(19) United States
(12) Patent Application Publication
(10) Pub. No.: US 2016/0152491 A1
(43) Pub. Date: Jun. 2, 2016

(54) SYSTEM AND METHOD FOR DEWATERING SLURRIES

(71) Applicant: The Board of Trustees of the University of Illinois, Urbana, IL (US)

(72) Inventors: Nandakishore Rajagopalan, Champaign, IL (US); Hafiz Hussein Mohamed Salih, Savoy, IL (US)

(21) Appl. No.: 14/953,571

(22) Filed: Nov. 30, 2015

Related U.S. Application Data
(60) Provisional application No. 62/085,831, filed on Dec. 1, 2014.

(51) Int. Cl. C02F 1/44; B01D 61/00; C02F 1/00

(52) U.S. Cl. CPC C02F 1/445; C02F 1/004; B01D 61/005; C02F 2101/10

(57) ABSTRACT

A system for dewatering slurries comprises a tower including a stack of forward osmosis (FO) cells. Each FO cell comprises a first portion for holding a feed slurry, a second portion for circulating a draw solution comprising an osmotic agent, and a semi-permeable membrane in between the first portion and the second portion. The first portion includes an agitation mechanism for mixing the feed slurry. During operation of the system, the feed slurry is transported downstream through the stack for dewatering to a predetermined solids content.

### RELATED APPLICATIONS

The present patent document claims the benefit of priority under 35 U.S.C. §119(e) to U.S. Provisional Patent Application Ser. No. 62/085,831, filed Dec. 1, 2014, which is hereby incorporated by reference in its entirety.

### TECHNICAL FIELD

The present disclosure is related generally to waste disposal of slurries/sludges and more particularly to dewatering of slurries.

### BACKGROUND

As-mined coal contains non-combustible impurities, sulfur containing minerals, and hazardous trace elements that need removal prior to use. The removal of impurities—coal cleaning or preparation—is predominantly carried out by water-based processes that produce waste streams. Such waste streams may be categorized by the particle size of the component solids. The larger particle size fraction can be readily dewatered and disposed of in waste piles or used for backfilling. The fine particle size fraction, on the other hand, poses a more significant challenge.

In some coal preparation plants, very fine coal particles are separated and recovered using froth flotation. The carryover of residual water in the clean coal product is undesirable as it makes coal storage and handling difficult, increases transportation costs, and reduces heating value. As the cost to dewater fine coal is three to four times higher than that to dewater coarse coal, much of this fraction is discarded. It has been reported that US coal producers discard between 27 and 36 million metric tons of fresh fine coal to refuse ponds each year. To date, approximately two to three billion metric tons of fine coal have been discarded in abandoned and active tailings ponds. Several drivers are propelling the development of new technologies to recover these fines, chief among them being economic loss and a desire to limit exposure to long-term environmental liability.

Dry cleaning technologies, alternative disposal methods such as backfilling, reduction of disposal volumes through ultrafine coal recovery, and reclamation of old slurry ponds have all been advanced as solutions. Other than dry cleaning technologies, all of these options require the removal of water from slurried solids.

There are several options for dewatering fine coal and refuse. Thermal dewatering, the application of heat to evaporate water, is possible but not desirable due to the thermal energy involved and associated safety hazards. Other methods for dewatering the fine size fractions typically involve filtration or sedimentation. These tend to involve complex pieces of equipment that consume substantial power, require conscientious operation and maintenance, and need redundant dewatering options in case of failure.

### BRIEF SUMMARY

An improved system for dewatering slurries comprises a tower including a stack of forward osmosis (FO) cells. Each FO cell comprises a first portion for holding a feed slurry, a second portion for circulating a draw solution comprising an osmotic agent, and a semi-permeable membrane in between the first portion and the second portion. The first portion includes an agitation mechanism for mixing the feed slurry. During operation of the system, the feed slurry is transported downstream through the stack for dewatering to a predetermined solids content.

An improved method of dewatering slurries comprises delivering a feed slurry to be dewatered into a first forward osmosis (FO) cell. The first FO cell is one of a plurality of FO cells stacked to form a tower, where each of the FO cells comprises a first portion separated from a second portion thereof by a semi-permeable membrane. A draw solution comprising an osmotic agent is flowed through the second portion, thereby generating an osmotic pressure gradient between the second portion and the first portion. The feed slurry is delivered to the first portion of the first FO cell and mixed or agitated. The osmotic pressure gradient induces water from the feed slurry to flow through the semi-permeable membrane to the second portion of the first FO cell, and water is removed from the feed slurry to form a dewatered slurry. The dewatered slurry is transported to an adjacent downstream FO cell, and the mixing of the slurry, flowing of the draw solution, and removal of water are carried out in the adjacent downstream FO cell. The transporting, mixing, flowing and removal are repeated until the dewatered slurry reaches a final solids content of at least about 60%.

### BRIEF DESCRIPTION OF THE DRAWINGS

FIG. 1A shows an exemplary system for dewatering slurries, and FIG. 1B is a simplified schematic of the system showing provisions for material transfer into, through and out of the system.

FIG. 2 shows an exemplary forward osmosis (FO) cell from the system of FIG. 1.

FIG. 3 shows an exploded view of the exemplary FO cell of FIG. 2.

FIG. 4 is a schematic of an exemplary open FO cell designed to accommodate custom membrane sizes and provide access to the cake layer in bench scale studies.

FIG. 5 shows a schematic diagram of a bench-scale FO system.

FIGS. 6A and 6B show estimates in vol. % and wt. %, respectively, for the particle size distributions of feed slurry samples C1, C2 and C3.

FIG. 7 shows data for cumulative water removed versus time (dewatering rate) for mixed and unmixed feed slurries.

FIGS. 8A and 8B show the dewatering rate for a 50 mL fine refuse slurry containing 20 wt. % and 50 wt. % solids, respectively.

FIG. 8C shows the dewatering rates for a 50 mL fine refuse slurry containing 20 wt. %, 30 wt. % and 50 wt. % solids.

FIGS. 9A and 9B show the cumulative water removed and slurry solids content, respectively, for slurries of different particle sizes over time.

FIG. 10 shows the effect of flocculation on the dewatering rate.

FIG. 11 shows the effect of gypsum addition on the dewatering rate.

FIGS. 12A and 12B show the effect of reducing total dissolved solids (TDS) in the feed slurry on the cumulative water removed and slurry solids content, respectively.

FIG. 13 shows average DI water flux for a single membrane measured after dewatering runs.

FIG. 14 shows reverse flux of draw solute measured after each dewatering run.

FIG. 15 shows average water flux and final solids content for 30 runs of C2 sample conducted with the same membrane coupon.

FIG. 16 shows the relationship between average water flux and solids content.

FIG. 17 shows variations in average water flux to achieve desired solids content.

FIG. 18 shows a photograph of an exemplary medium-sized FO dewatering cell with an automated scraper mounted in the first portion above the semi-permeable membrane.

FIG. 19 shows a photograph of an exemplary large-sized FO dewatering cell.

FIGS. 20A and 20B show the dewatering performance of the C2 sample containing 40 wt. % and 30 wt. % solids, respectively.

FIG. 21 shows the dewatering performance of 1000 g of the C1 sample using the large FO cell shown in FIG. 19.

FIGS. 22A-22C show the dewatering performance of 1000 g, 2000 g, and 3000 g, respectively, of the C2 sample using the large FO cell shown in FIG. 19.

FIG. 23 shows the impact of solids loading on average water flux.

### DETAILED DESCRIPTION

In a departure from active dewatering approaches pursued in the past, a passive dewatering approach enabled by the self-directed transport of water from a waste slurry to an osmotic agent is exploited in a multi-cell forward osmosis (FO) system capable of dewatering to greater than 60% solids. Using the system and method described herein, dewatering to a desired solids content may be achieved by inducing an osmotic pressure difference instead of mechanical pressure.

Water transport can occur as a consequence of the difference in the activity of water in the waste slurry compared to that in the osmotic agent. For example, a feed solution with a relatively low concentration (c₁) of ionic or nonionic solute may be separated by a semi-permeable membrane barrier from a solution (e.g., an osmotic agent or draw solution) containing an elevated concentration (c₂) of an ionic or non-ionic solute. As the activity of water in the feed solution is higher than that in the osmotic agent, water flows from the feed solution to the osmotic agent, achieving dewatering of the feed solution. To avoid counter diffusion of the osmotic agent into the material being dewatered, a semi-permeable membrane is positioned between the feed solution and the osmotic agent.

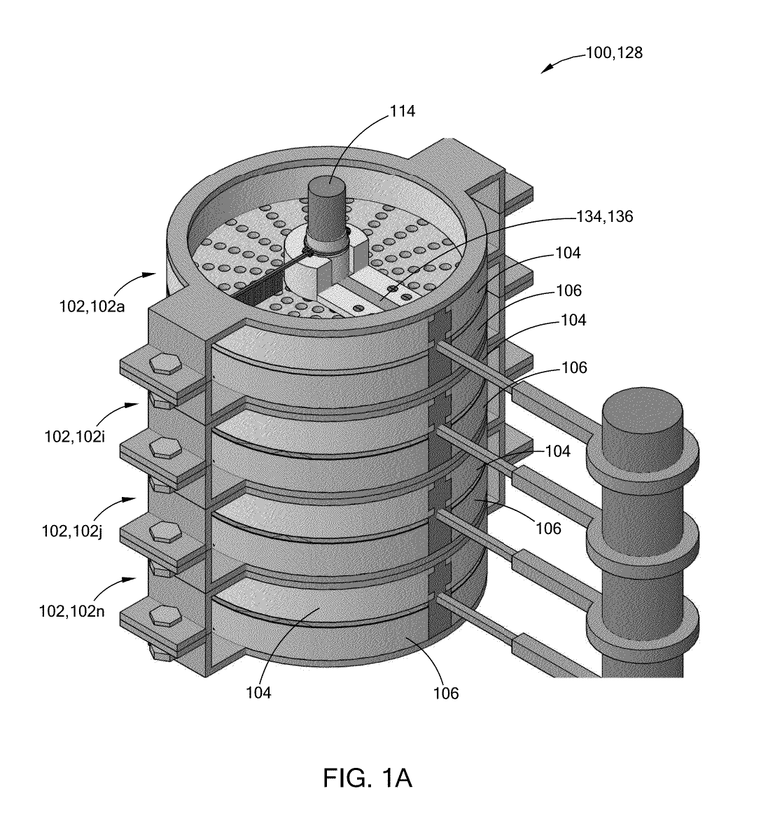

FIG. 1 shows an exemplary system 100 for dewatering slurries utilizing the passive dewatering approach described above. The system 100 includes a plurality of osmosis (FO) cells 102 stacked to form a tower 128. The system 100 may include n of the FO cells 102, where 2≦n≦100. In this example, n=4. Each FO cell includes a first portion 104 for containing a feed slurry, a second portion 106 for containing a draw solution comprising an osmotic agent, and a semi-permeable membrane 108 in between the first portion 104 and the second portion 106. The feed slurry is transported from the first FO cell 102a downstream through the tower 128 for dewatering to a predetermined solids content. Each FO cell 102 may include a flow regulation mechanism 134, described further below, to control the flow of dewatered slurry from the FO cell to an adjacent downstream FO cell. All of the FO cells can be readily physically separated from one another for convenience, changing membranes, cleaning and/or troubleshooting.

The system 100 may also include a slurry delivery mechanism 130 for continuously feeding a slurry to the first FO cell 102a, which may be the topmost FO cell in the tower 128. The slurry delivery mechanism 130 may take the form of a system of tanks, pumps and pipes in fluid communication with the first FO cell 102a. Alternatively the slurry may be delivered into the system using pneumatic means or by gravity or by another suitable mechanical means. A cake removal mechanism 132 may be configured to remove slurry or dry cake from one or more of the FO cells (e.g., from the bottommost or last cell 102n) after the desired solids content has been reached. The cake removal mechanism 132 may take the form of a discharge chute that is further aided by mechanical means such as a rotating rake and/or vibrationally induced movement. Optionally, in the case of non-flowable cakes, the bottommost cell may incorporate a removable container 132a with a porous bottom wall on which the cake is allowed to dry and physically removed as one unit. As would be understood by one of ordinary skill in the art, the terms “cake,” “filter cake” and “filter cake layer” refer to the particulate solids (or particles/powders) that accumulate in the first portion of the FO cell as the feed slurry is dewatered.

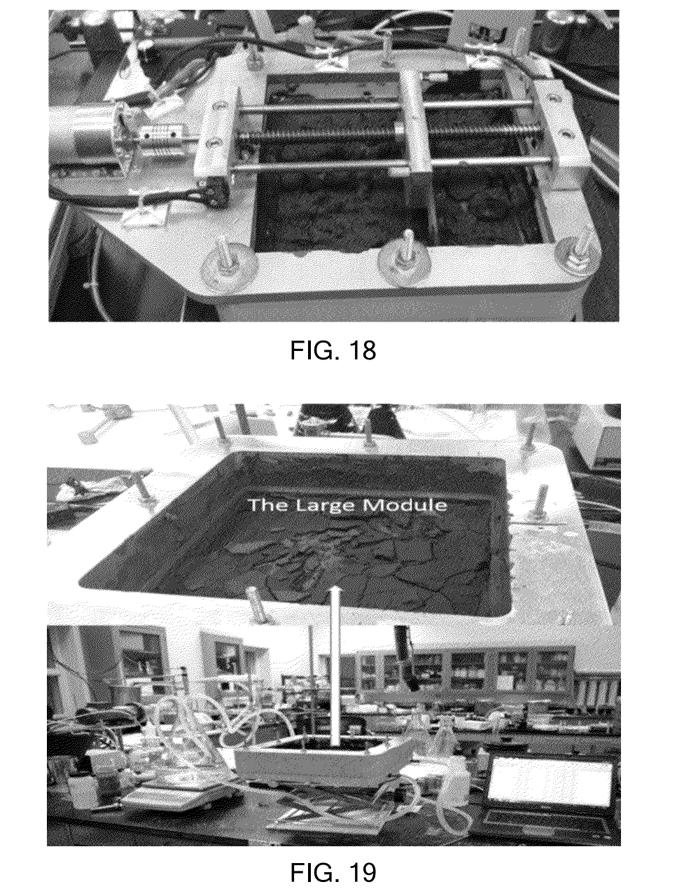

The FO cell may have a circular cross-sectional shape and a cylindrical configuration, as shown in FIGS. 1-3. Alternatively, the FO cell may have a rectangular cross-section and a rectangular parallelepiped configuration, as shown in FIGS. 18 and 19.

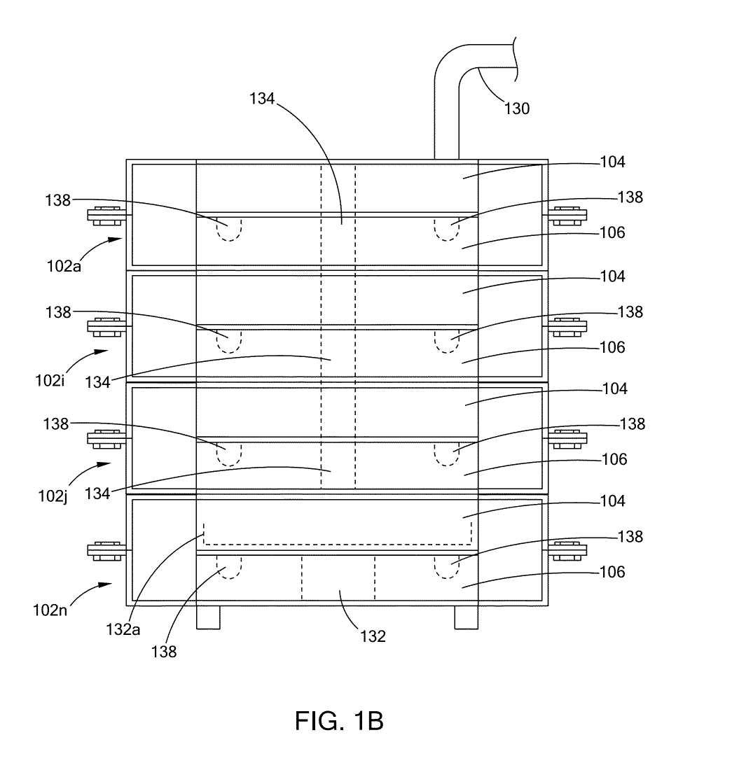

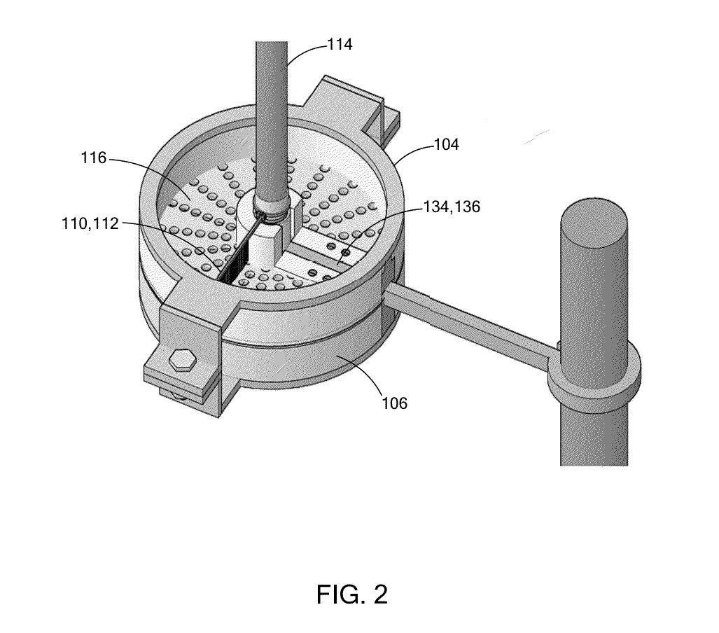

The first portion 104 of each FO cell includes an agitation mechanism 110 for mixing the feed slurry, such as a rotatable and/or translatable scraper or rake. The agitation mechanism 110 may also or alternatively comprise a source of vibrational energy, such as an ultrasonic transducer or other device connected to the FO cell. Shown in the exemplary FO cell 102 of FIG. 2 is a rake 112 attached to a rotatable central shaft 114. Rotational and/or reciprocating motion of the rake 112 during operation of the FO cell 102 can be effective for breaking up the cake layer on top of the semi-permeable membrane 108 and thereby obtaining a higher dewatering rate. Advantageously, the rake 112 or other agitation mechanism 110 may be automated. A motor may be connected to the rotatable central shaft 114 by a belt or pulley, for example. Mixing or agitation may be carried out during operation of the FO cell until no longer feasible (e.g., due to development of excessive viscosity of the slurry or cake layer).

The second portion 106 of each FO cell may include an inset channel 138 for circulation of the draw solution in and out of the FO cell 102. A pump may be in fluid communication with an inlet to the channel 138 to circulate the draw solution at a desired flow rate. The draw solution may move in a direction counter to the flow of the feed slurry, which may be referred to as counter current, and the system may optionally operate with independent draw solution circuits (referred to as cross current) or in a mixed mode.

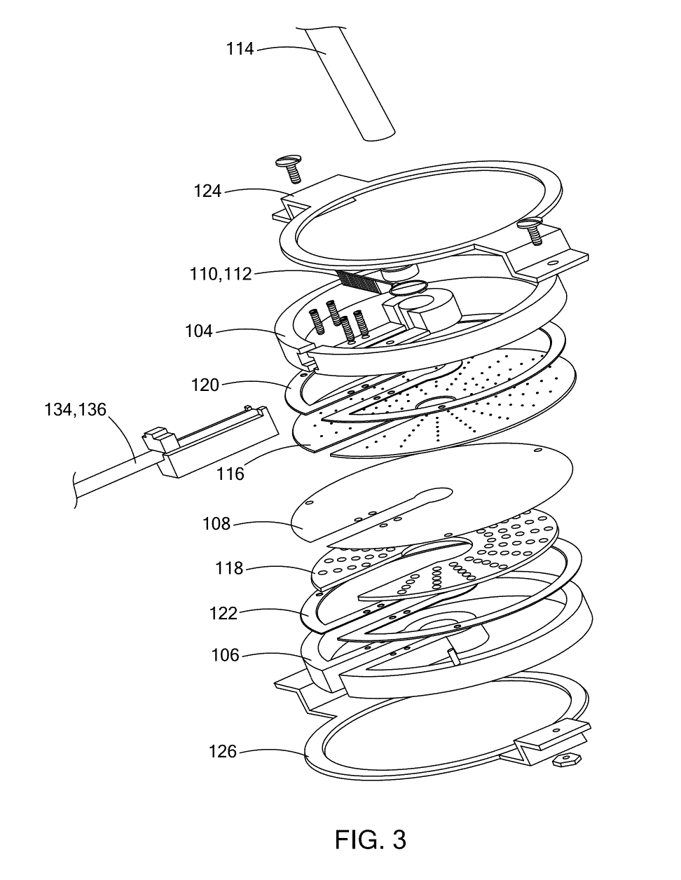

FIG. 3 shows an exploded view of the exemplary FO cell 102 of FIG. 2. The semi-permeable membrane 108 and various parts of the first portion 104 and the second portion 106 introduced above can be seen.

The semi-permeable membrane 108 may comprise an inorganic and/or organic material and may take the form of an ultrafiltration membrane, a nanofiltration membrane or a reverse osmosis/forward osmosis membrane. The type of membrane used for the FO cell may depend on the draw solution employed. For example, for salt-based draw solutions, nanofiltration, reverse osmosis or forward osmosis membranes may be used. For draw solutions comprising MgSO₄, a nanofiltration membrane may be preferred. Suitable semi-permeable membranes 108 may be fabricated from cellulose triacetate or a thin-film composite comprising more than one polymer film, such as those commercially available from HTI Inc. (Albany, Oreg.) or Porifera, Inc. (Hayward, Calif.), for example, that are specifically engineered for forward osmosis. Alternatively, commercially available nanofiltration/reverse osmosis membranes such as those available from Dow Water & Process Solutions (Edina, Minn.) or GE Water & Process Technologies (Trevose, Pa.) can be used as well. For systems employing high molecular weight draw solutes, ultrafiltration membranes may also be suitable.

Advantageously, the semi-permeable membrane 108 has a salt rejection of from about 20% to about 90% in reverse osmosis (RO) operation mode, with the lowest possible rejection being used compatible with the slurry being processed. Salt rejection may be calculated based on the salt passage, which is the ratio of the concentration of salt on the permeate side (Cₚ) of the semi-permeable membrane relative to the average concentration in the feed slurry (C_{fs}), where the salt rejection is equivalent to 100%−(Cₚ/C_{fs})·100. In some cases (e.g., for sodium chloride-based draw solutions), the semi-permeable membrane 108 may exhibit a salt rejection of greater than 90%, or preferably greater than 95%. The salt rejection may also be greater than 90% or greater than 95% for ionized or unionized organic solutes. The semi-permeable membrane 108 may be engineered to minimize thickness and concentration polarization to improve transport properties of the membrane.

The FO cell 102 may include a protective layer 116 on a side of the semi-permeable membrane 108 facing the first portion 104. The purpose of the protective layer 116 is to protect the membrane 108 from abrasion that may be caused by the motion of the particulate solids from the slurry during mixing. Typically, the agitation mechanism 110 described above is mounted a few millimeters (e.g., about 1 mm to about 3 mm) above the protective layer 116.

The protective layer 116 may take the form of a screen mesh comprising a metal or a polymer, such as stainless steel or a geotextile fabric, mounted directly on the semi-permeable membrane 108. The protective layer 116 is typically porous with a pore size distribution in the range of from about 20 microns to about 60 microns, or from about 25 microns to about 53 microns. The second portion 106 may also comprise a screen mesh 118 to support the membrane. The second portion 106 can have further channels, meshes, or other mixing mechanisms incorporated to promote mixing of the draw solution and to minimize concentration polarization. The screen mesh 118 and/or any additional mixing mechanisms of the second portion 106 may be mounted directly adjacent to the membrane 108 on a side facing the second portion 106 (e.g., under the membrane 108).

The FO cell 102 may further include, to provide effective sealing, a first gasket 120 disposed between the semi-permeable membrane 108 and the first portion 104, and a second gasket 122 disposed between the semi-permeable membrane 108 and the second portion 106. A top clamp 124 and a bottom clamp 126 may be used to mechanically compress the gaskets 120,122 and form a leak-proof cell 102. Consequently, the semi-permeable membrane 108 and the protective layer 116 may be sealed between the gaskets. The first portion of the FO cell may remain open to ambient atmosphere allowing for access to the feed slurry and the protective layer 116 on the semi-permeable membrane 108.

The flow regulation mechanism 134 mentioned above for controlling the flow of the slurry from an upstream FO cell 102i to an adjacent downstream FO cell 102j may take the form of a retractable plug 136 sized to fit into an opening or channel in each FO cell. The channel may extend from the first portion 104 entirely through the thickness of the second portion 106. The retractable plug 136 may be inserted into the channel to contain the slurry within the cell 102i, and then may be retracted to expose the channel and allow the dewatered slurry to flow to the next cell 102j, or to exit the system 100. The retraction of the plug 136 may be effected manually or automatically via motion in a radial direction or in a height direction, for example.

In addition to a dewatering system, a method of dewatering slurries is also described. The method exploits an osmotic pressure gradient for achieving dewatering to high solids contents, and may utilize any embodiment of the dewatering system described in this disclosure.

The method may entail delivering a feed slurry to be dewatered into a first FO cell, the first FO cell being one of a plurality of FO cells stacked to form a tower. The system may include n FO cells, where n is an integer from 2 to 100. Each of the FO cells comprises a first portion separated from a second portion thereof by a semi-permeable membrane. The feed slurry is delivered into the first portion of each FO cell, upstream of the semi-permeable membrane, and the second portion of each FO cell contains a draw solution comprising an osmotic agent. The feed slurry is mixed in the first portion of the first FO cell, preferably by an automated mixing or agitation mechanism. An osmotic pressure gradient between the feed slurry and the draw solution induces water from the feed slurry to flow through the semi-permeable membrane to the second portion of the first FO cell. The semi-permeable membrane may have any of the characteristics described in this disclosure. The semi-permeable membrane may be oriented with an active layer thereof facing the draw solution while a support layer on the opposing side faces the feed slurry, or the active layer may face the feed slurry while the support layer faces the draw solution. Water is removed from the feed slurry to form a dewatered slurry having a predetermined solids content. Mixing or agitating the slurry during dewatering may help to prevent formation of a thick or viscous filter cake layer, as discussed above, thereby increasing the rate of water removal. The dewatered slurry is then transported to a downstream FO cell, where the mixing of the slurry and the osmosis-induced water removal are carried out again.

In the course of the method, the mixing and water removal take place in some or all of the FO cells in the stack using the dewatered slurry obtained from an adjacent upstream FO cell. The process continues until the desired solids content is reached and dewatering is completed. Due to the effectiveness of the method, the final dewatered slurry formed in the j^{th} or the n^{th} (last) FO cell has a final solids content of at least about 60%, and it may also be at least about 70%, at least about 75%, or at least about 80%.

The feed slurry employed in the method may comprise waste material obtained from mining, manufacturing, water treatment or biotechnology. For example, the feed slurry may include coal particles obtained from the mining industry. Experiments described below establish that dewatering of coal refuse slurry to well in excess of 70% solids can be routinely achieved using an osmotic gradient as described above without application of any external pressure.

The dewatering rate may depend on the total dissolved solids (TDS) level of the slurry. Typically, water is removed from the slurry at an average rate of from about 2 liters/m²/h (LMH) to about 20 LMH. The higher the TDS level, the lower the driving force and the lower the dewatering rate or flux. Experiments show that the solids content has less of an impact on the dewatering rate until the formation of a network of solids and initiation of consolidation. Typically, the average rate of water removal (the dewatering rate or flux) is at least about 4 LMH, at least about 5 LMH, at least about 7 LMH, at least about 9 LMH, or at least about 11 LMH, with removal rates usually being 20 LMH or lower.

The draw solution circulated through the second portion of the FO cell may be an aqueous solution having an osmotic pressure of at least about 10 psi, at least about 30 psi, or at least about 50 psi. The draw solution may be circulated at a flow rate that has a Reynolds number of at least 300. A higher Reynolds number is preferable to minimize concentration polarization consistent with energy consumption. Alternatively, a lower Reynolds number flow may be utilized in conjunction with process intensification methods such as static mixers, or field based mixing such as acoustically induced mixing. The osmotic agent employed in the draw solution may include one or more of the following: sodium chloride, magnesium sulfate (MgSO₄), a thermolytic salt or another monovalent and/or divalent salt; glycerol; sucrose; a polymer; and a switchable polarity solvent. The polymer may be a high molecular weight polymer, a thermoresponsive polymer or another suitable polymer, etc. as generally known in the forward osmosis literature.

Experiments have shown that the addition of substantially spherical particles (e.g., gypsum particles) to the feed slurry may be beneficial for disrupting the cake structure, thereby leading to improved dewatering rates. For this reason, substantially spherical particles of gypsum or another suitable material may be added prior to delivering the slurry to the first FO cell. As used herein, the term “substantially spherical particles” may refer to particles having a length-to-width aspect ratio of about 1 (e.g., within about 50% of 1). The substantially spherical particles may be included at a concentration of from about 0.1% to about 20%. The exact amount may depend on the process and cost objectives. It also has been observed that increased particle sizes in the slurry are associated with higher dewatering rates. Thus, increasing the particle size of the particulate solids in the slurry (e.g., through agglomeration or flocculation) may be beneficial to the dewatering process. Preferably, the slurry includes particulate solids having a particle (or agglomerate) size of about 1 micron or greater.

This may be qualitatively understood by using phenomenological relationships for flow through packed beds. Typically, flow through packed beds is described by a relationship like the Kozeny-Carman relationship. In an undisturbed bed, the resistance to flow is dictated by particle size, particle size distribution, porosity, and bed height in addition to properties such as viscosity. The resistance is inversely proportional to the square of the particle size. As the particle size distribution gets broader, the closer the achievable packing, resulting in lower porosity and an increased resistance to flow. Irregularly shaped particles also tend to pack more tightly compared to spherical particles, and this also can increase resistance to flow.

### Examples

In the following examples, osmotic dewatering of fine coal refuse and ultrafine coal is shown to be technically feasible and economically scalable. The feasibility of osmotic dewatering was investigated using three feed streams obtained from the coal preparation plant at the American Coal Company's Galatia Mine. One stream came from the thickener underflow and represented coal refuse (C2). The other two streams were product streams—product slurry from the froth flotation process (C1) and overflow product from spiral sieves (C3).

Osmotic dehydration was carried out in custom-built, rectangular FO cells. The rectangular FO cell was scaled by a factor of 20 in terms of membrane area and the amount processed was scaled by a factor of 60. The performance noted in smaller cells was comparable to those obtained with larger cells, validating the feasibility of scale-up of the system. The robustness of a semi-permeable membrane was tested by using the same membrane coupon repeatedly over thirty trials. No deterioration in performance was noted over these trials. Importantly, the membrane was easily cleaned by the use of a water rinse.

### 1. Experimental Procedures

Feed Slurry Characterization:

Representative samples of various slurry streams were collected from the American Coal Company Galatia Mine in July 2013. They are described in Table 1. The type of solids in streams C1 and C3 corresponds to coal while the particle type in stream C2 is a mixture of various refuse materials.

The fine refuse sample, C2, was utilized for the bulk of the work due to its smaller particle size and the preponderance of clay type materials that are known to be hard to dewater. Towards the latter part of the project, additional samples of C2 were collected and used as received without any extensive characterization. All original samples were analyzed for total solids, total dissolved solids (TDS), ionic composition, and particle size. TDS refers to the total dissolved (filterable) solids as determined by the method set forth in Method 2540 (Standard Methods for the Examination of Water and Wastewater). Particle size analyses of samples C1 and C2 were carried out at Particle Technology Labs (PTL) in Downers Grove, Ill. The analysis was conducted using a Malvern® MasterSizer laser diffraction (LD) system. This instrument is considered an ensemble analyzer that calculates a volume distribution from the laser diffraction pattern. Sample C2 was sieved using #10, #14, #18, and #20 mesh screens to separate particles larger than 850 μm prior to the LD analysis.

TABLE 1
Sample locations and IDs

| | | | Volume |
|---|---|---|---|
| Sample | Location | ISTC ID | (gallons) |
| Flotation cell product | Cells A & B* | C1 | 10 |
| Thickener underflow | End Point of Plant | C2 | 15 |
| (Waste) | | | |
| Spirals product after sieves | Spiral Sieve | C3 | 15 |
| | Discharge | | |
| Screen bowl feed | Mix of C1 and C3 | C4 | 10 |

*Cell A is expected to contain a higher concentration of ultrafine particles relative to Cell B.

Manipulation of Slurry Solids Concentration:

Feed slurries were prepared using the C2 thickener underflow sample. The solid content of C2 was separated from the sample using a centrifuge (Model j2-21m, Beckman Coulter in Brea, Calif.). Fine solids remaining in the supernatant were filtered and added to the settled solids. In order to remove dissolved salts from samples, DI water washes were utilized until conductivity reading was below 100 μS. The fine refuse was then dried at 105° C. for 24 hours. Feed slurries of 20%, 30%, and 50% (w/w % or wt. %) were prepared by mixing the dried solids with pre-measured amounts of a synthetic saline wastewater prepared to mimic the average composition of ions in sample C2.

Slurry TDS Adjustment:

The TDS of the C2 sample was adjusted by adding washed and dried solids to obtain a solids content of 30% (w/w) with a saline solution that corresponded to 100%, 50%, and 25% of the TDS of the C2 slurry.

Particle Size Manipulation by Flocculation:

The C2 thickener underflow sample was diluted to allow for better polymer/solids interaction. The dilution rate was 2:1 (2 volumes DI water to 1 volume C2). Sample C2 solids content was approximately 10% after dilution. This control sample was used to ascertain the impact of flocculation on the dewatering rate.

Effect of Particle Type/Particle Size Distribution Effect:

Solids from slurries C1, C2, and C3 were separated and used to make 30% slurries in synthetic saline solution that corresponded to 100% of the TDS of the analyzed C2 slurry. As indicated above, streams C1 and C3 included coal particles while the stream C2 is a mixture of various refuse materials, including clay, coal and silt particles.

Effect of Adding External Solids:

Gypsum, a by-product of flue gas desulfurization, was obtained from Southern Illinois Power Co-operative in Marion, Ill. and mixed with C2 slurry at 10% and 20% by weight of slurry prior to dewatering.

Membrane Selection:

Membranes tested included a cellulose triacetate membrane from HTI in Albany, Oreg., a thin film composite (TFC) nanofiltration membrane from Sepro, Inc. in Oceanside, Calif., and a laboratory cast TFC using four different ultrafiltration supports, also from Sepro. Substrates were polyacrylonitrile (PAN450), polyethersulfone (PES20), and polysulfone (PS35). Based on preliminary testing, the cellulose triacetate (CTA) membrane was chosen due to its fouling resistance.

FO Cell:

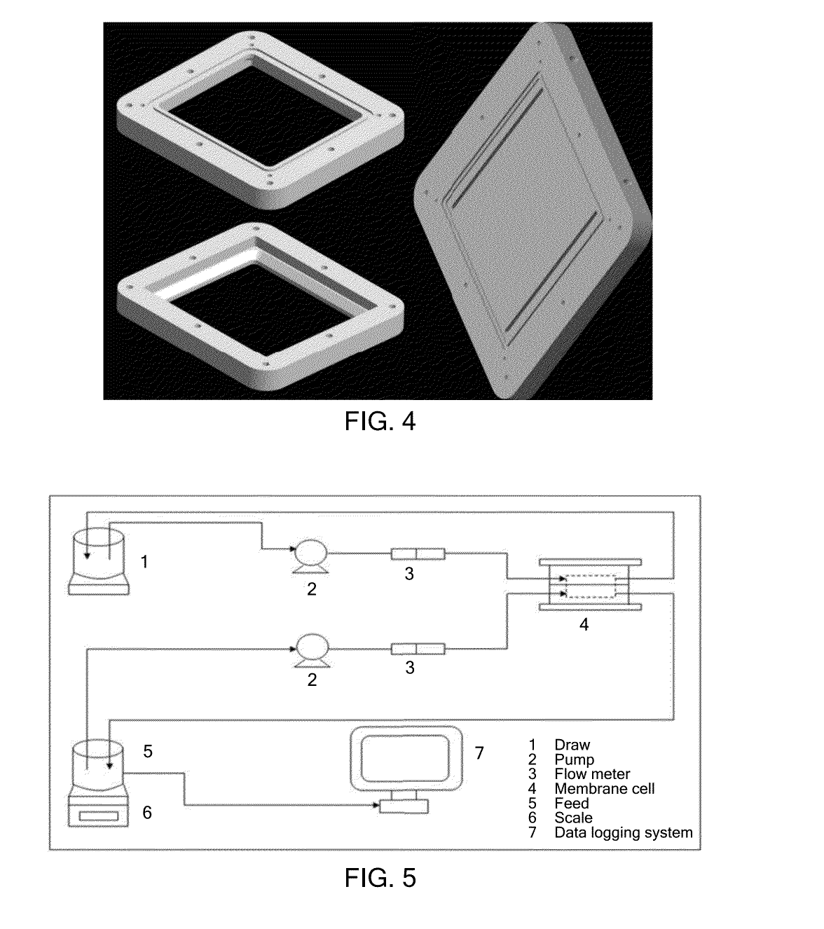

The FO rectangular open cell shown in FIG. 4 was 3D-prototyped in house to accommodate custom membrane sizes and provide access to the cake layer. It was made of acrylic with separable top and bottom parts. The bottom portion has an inset channel through which the draw solution was circulated at a rate of 850 mL/min. The membrane was sealed between the two parts with O-rings/gaskets. To promote mixing of the draw solution, a plastic spacer was used in the draw solution channel. The active area of the membrane was 0.0026 m². In later experiments, the top of the membrane was covered with a stainless steel mesh to protect the membrane surface from potential abrasion caused by relative movement between the particles and the membrane on mixing.

Flux Measurements:

FIG. 5 shows a schematic diagram for the bench-scale FO experimental system. The membrane was oriented with the active layer facing the draw solution while the support layer faced the feed solution. Prior to dewatering slurries, membranes were checked for integrity using DI water.

The draw solution contained 20% MgSO₄ (w/w). The feed solutions were either DI water or slurries, either artificially prepared or used as-received or after additional treatment. Water flux was obtained by measuring the weight change of draw solutions using an electronic balance connected to a data logging system. The reported flux values are averages over the entire experiment except where noted. The water flux J_{w} (kg/sq·m/h) in the system is calculated by:

$${J}_{w} = \frac{Δ M}{A * Δ t}$$

where ΔM refers to the change in mass of draw solution with time, Δt, and A is the area of the membrane.

Operational Mode:

The formation of a consolidated cake layer is believed to provide the dominant resistance to water transport and limited dewatering. Thus, in this work, by mixing the slurry repeatedly until the disappearance of free standing water, the formation of a consolidated cake layer was avoided. This mixing was done manually using a plastic scraper. The rheology of the C2 slurry changes markedly during dewatering. While high water content suspensions are easily mixed, the suspension becomes a stiff, viscous mass that is difficult to move during later stages. Typically, at this point, the mass was not mixed but allowed to dewater only under the osmotic gradient. Initial experiments compared the effect of dewatering rates under mixing and non-mixing conditions.

### 2. Experimental Results and Discussion

Scalability of the FO Cells:

The scalability of the cell design was tested using two other cells. The intermediate sized cell represented a scale-up factor of seven in terms of membrane area. The largest cell tested in this project represents a scale-up factor of 20 in terms of membrane area. This was limited primarily by the size of membrane sheets available commercially. The largest volume processed was three liters, which represented an increase of about 60 relative to the smaller cells. A mechanical mixing arrangement was also designed and tested to illustrate automation.

Slurry Characterization:

The samples, analyzed individually for aqueous ionic composition, showed little variation indicating a common water circuit as would be expected from the preparation plant flow sheet. Table 2 reflects the average ionic composition of all samples. The composition in Table 2 was used to create a synthetic matrix for experiments. The total dissolved solids content (TDS) of the synthetic matrix was 8500 mg/L.

TABLE 2
Average composition of ions in samples C1-C4

| Cations | | | Anions | | |
|---|---|---|---|---|---|
| EPA 200.7 | mg/L | meq/L | EPA 300.0 | mg/L | meq/L |
| Sodium | 2828.75 | 122.99 | Chloride | 3536.50 | 99.62 |
| Potassium | 32.80 | 0.84 | Sulfate | 1852.50 | 38.59 |
| Calcium | 188.75 | 9.44 | | | |
| Magnesium | 44.85 | 3.74 | | | |
| Total | | 137.00 | | | 138.21 |

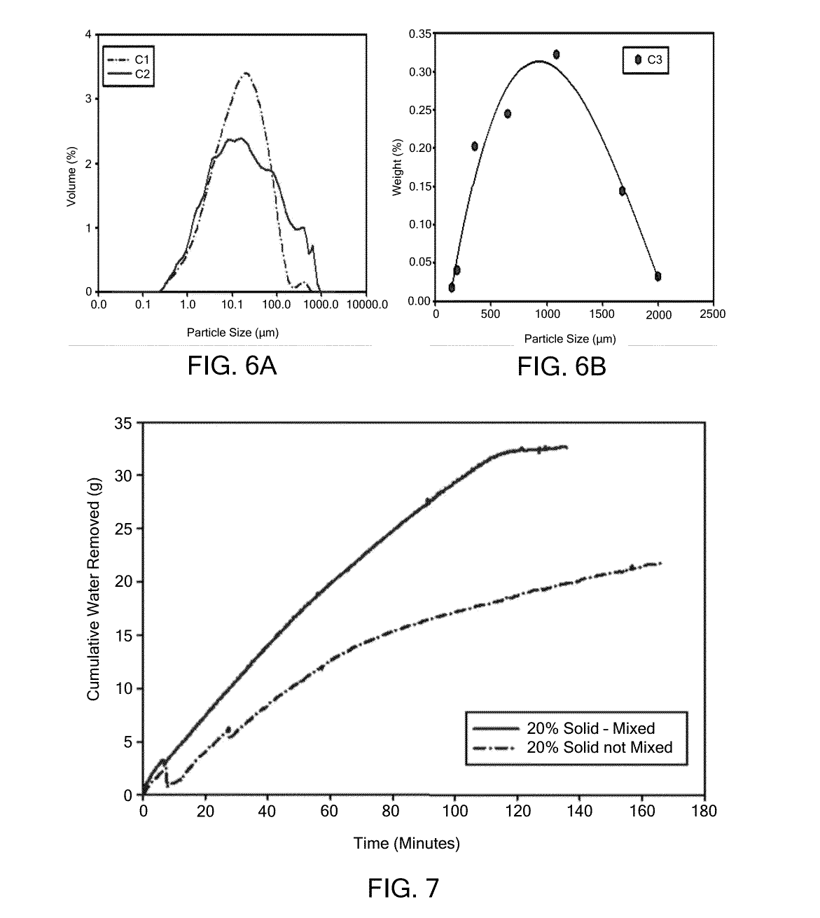

Table 3 lists percent solids of sample streams. Samples C1A and C2A represent the solids fraction in froth floated ultrafine coal. The higher solids content in Sample C3 represents the ease of dewatering larger sized particles from the spiral circuit. Sample C2 represents the solids fraction in the refuse stream currently obtained by chemical addition and thickening in the coal preparation plant. FIG. 6 provides the estimated volume distribution for a calculated equivalent spherical diameter for samples C1, C2, and C3. Only 1.0% of the particles in sample C2 were larger than 850 μm. Sample C3 contained much larger particles.

TABLE 3
Solids content of various slurry streams sampled within coal
preparation plant

| Sample | Percent Solids (w/w) |
|---|---|
| C1A | 13.8% |
| C1B | 4.35% |
| C2 | 31.6% |
| C3 | 48.0% |
| C4 | 6.2% |

Coal Dewatering:

Dewatering of coal refuse slurry with a solids content of 20% was conducted using the rectangular FO cell. The sample volume used was fifty milliliters. Experiments were conducted under both mixed and non-mixed conditions. FIG. 7 shows that mixing is beneficial to achieve a faster dewatering rate. Closer inspection reveals two distinct regions: an initial faster rate and a second slower rate. In the experiment with no mixing, the initial faster rate is seen for a shorter period. In the experiment with mixing this initial linear period is extended for a longer time. This suggests that water is being brought into close proximity with the membrane surface as the cake is mixed. During the slower periods, when mixing has been discontinued, the slower dewatering rate is a result of the extra resistance imposed by the cake.

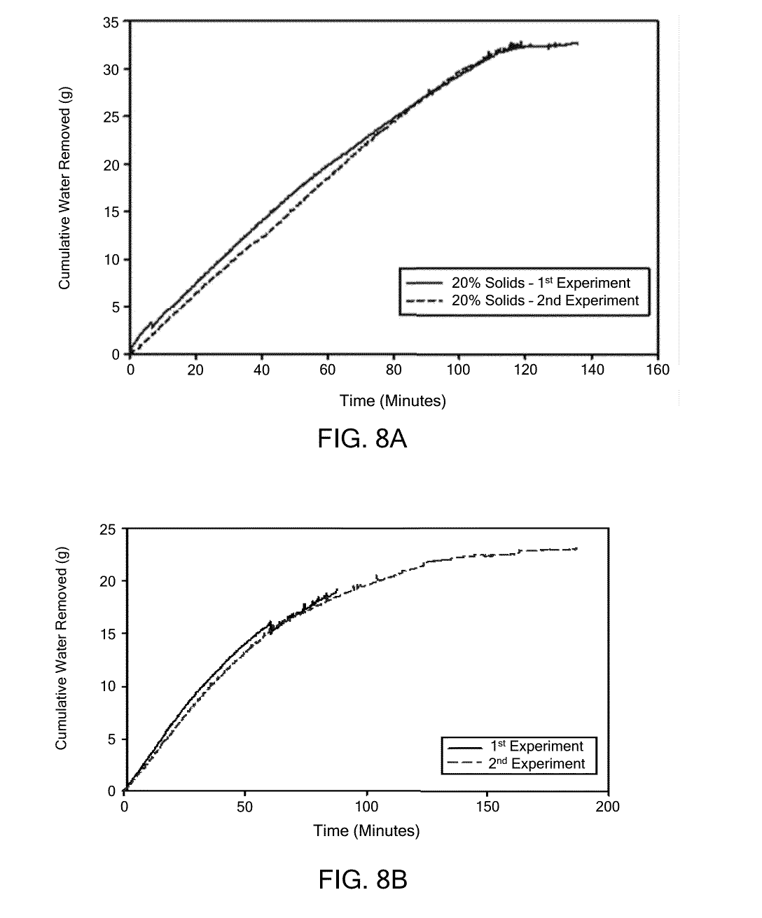

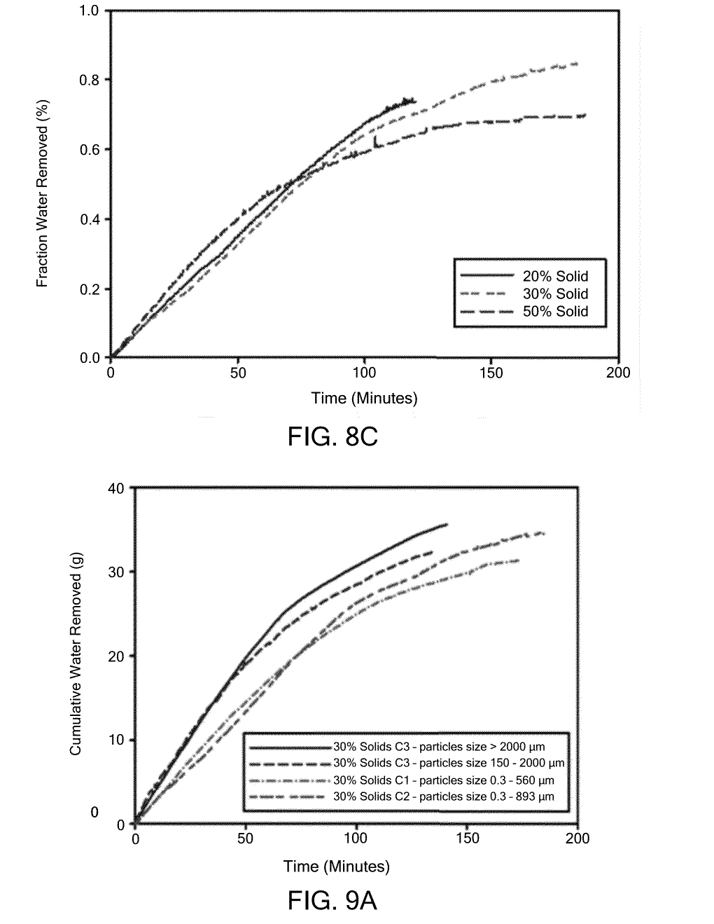

FIGS. 8A and 8B illustrate the reproducibility of dewatering achieved using 50 mL refuse samples with 20% and 50% solids content, respectively. The linear rate for the lower solids content extends for a longer time as there is more free water compared to the 50% solids content sample. FIG. 8C is a comparative illustration of the rate of dewatering 50 mL samples with three different solids contents (20, 30, and 50 wt. %) in synthetic saline solution. It is apparent that the dewatering rate during the early and middle phases of dewatering is primarily independent of the solids content, as would be expected when there is free water present in the samples. As the cake becomes unsaturated and viscosity increases to the point that mixing is discontinued, dewatering rates become dependent on cake properties. Samples with larger solids content exhibit more resistance, as would be expected.

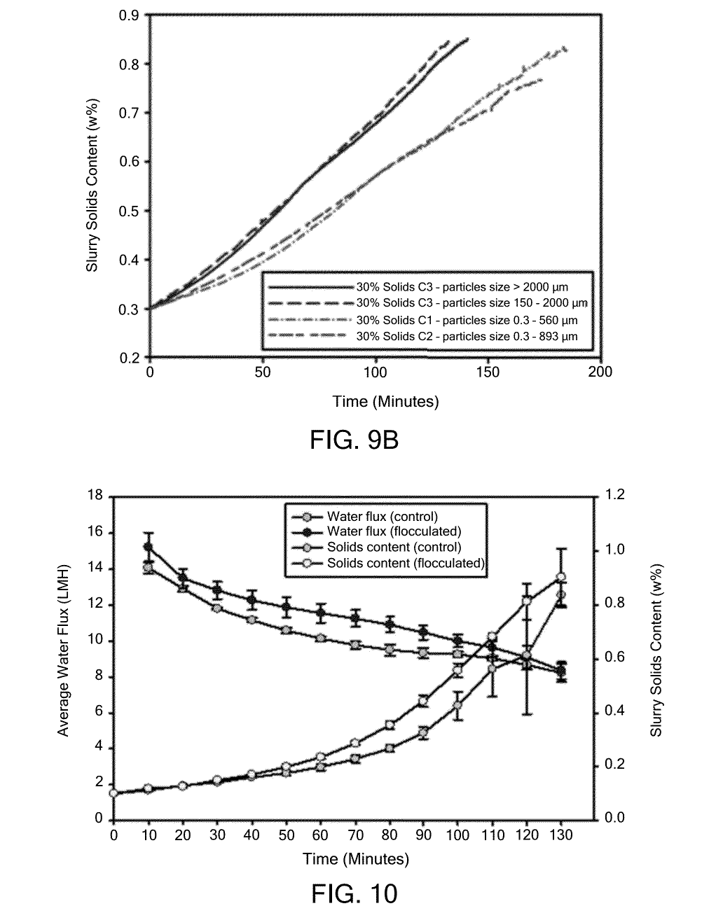

The effect of particle size and type are reflected in the data presented in FIGS. 9A and 9B showing that an increase in particle size results in an increased rate of dewatering. The dewatering rate difference between samples C1 and C2 is not appreciable given the similarity in particle sizes; however, these samples have a slower rate of dewatering compared to the dewatering of coarse particle fractions from the spiral classifier. The larger particle size and potentially the nature of particle type seem to have an impact on the extent of dewatering; i.e., the coarser particles seem to exhibit relatively lower capillary pressure. The effect of particle nature—coal or clay—is harder to discern and may require additional experiments.

The use of flocculants appears to have a beneficial effect on dewatering as shown in FIG. 10. Flocculation is designed to increase particle size, which is expected to aid dewatering; however, this was not apparent from the particle size analysis of flocculated suspensions. The most likely explanation for this may be non-representative sampling as visual indicators and filtration using 40-mesh polypropylene suggest that particles were fully retained indicating an increased particle size relative to native slurry.

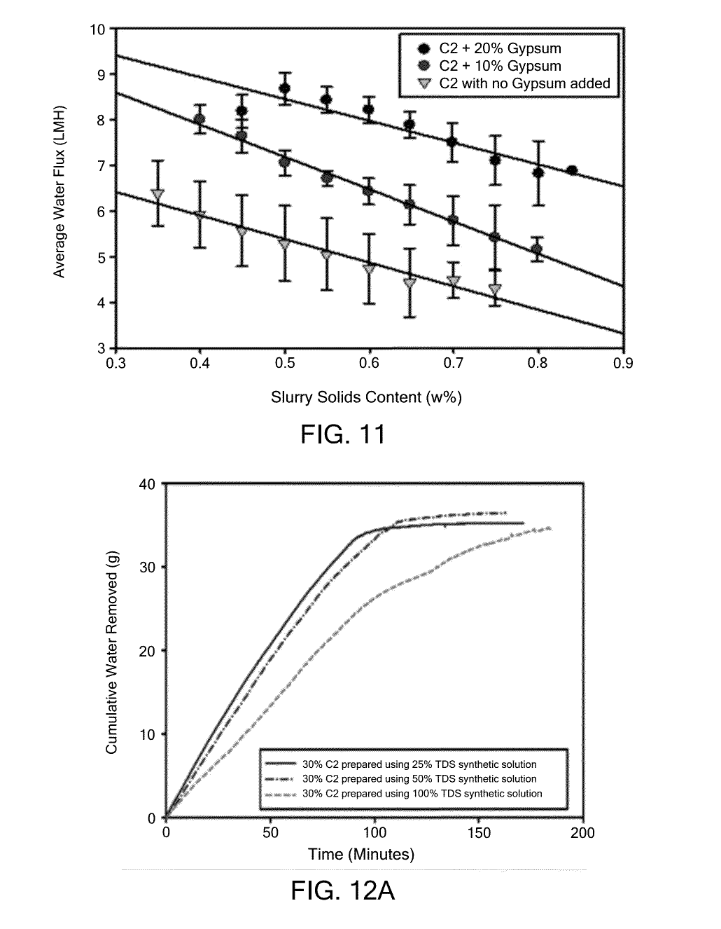

The addition of gypsum also appears to have a beneficial effect on dewatering as shown in FIG. 11. Gypsum is known to interact with clayey soils and is used in soil conditioning applications. When mixed with coal refuse slurry as in this study, it appears to have increased the hydraulic conductivity. The morphology (size, shape, and/or surface) of solid particles in sample C2 (after dewatering) and of gypsum were obtained using an Energy FEI/Philips XL30 FEG scanning electron microscope (SEM). SEM images indicated that gypsum particles are spherical while particles in sample C2 resemble flakes.

It was also of interest to determine the effect of the feed slurry osmotic pressure, as measured by TDS, on the dewatering rate,

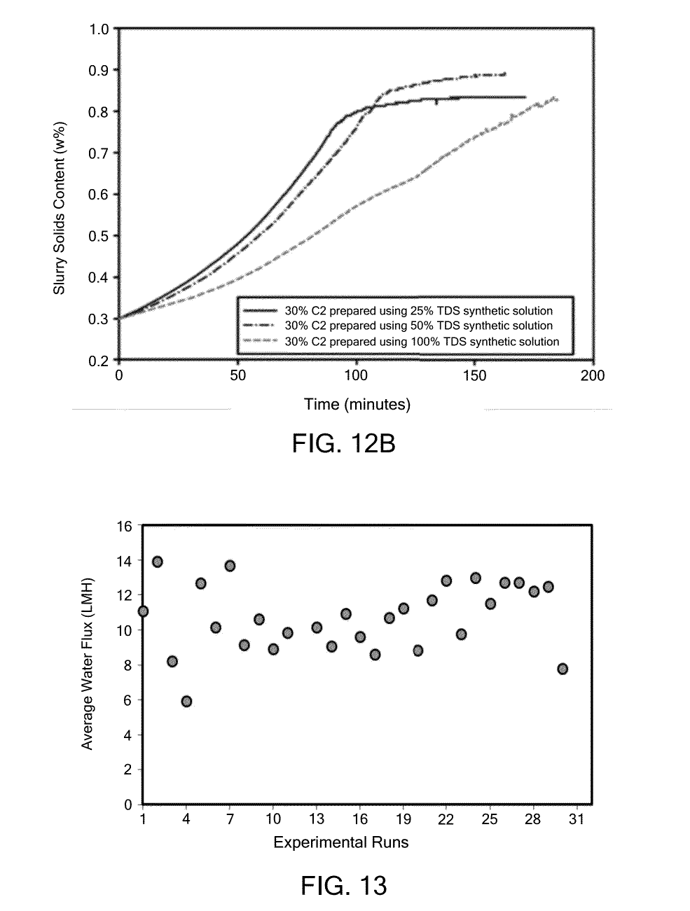

J=k*(π_{d}−π_{f})

where π_{d} and π₁ represent the osmotic pressure of the draw solution and feed slurry, respectively. Lowering the osmotic pressure of the feed solution is expected to increase the driving force and lead to greater flux. This increase is not necessarily linear due to accumulation and depletion of ions at the membrane interface—a phenomenon termed concentration polarization. In this study, the effect is clear that an increase in driving force results in greater driving force, but not necessarily linearly. For example, while a halving of the TDS from 100% to 50% results in a significant increase in the dewatering rate, a further halving does not result in a proportional decline (see FIGs. 12A and 12B).

These results indicate that it is possible to dewater coal refuse slurry, froth floated ultrafine coal, and coarser fine coal fractions to above 70% solids content without the application of mechanical pressure. Moreover, the rate of dewatering can be increased by manipulating factors such as particle size through flocculation, through the addition of external materials such as gypsum, and by reducing the feed osmotic pressure.

Membrane Cleanability and Reusability:

The same CTA membrane was used repeatedly for thirty experiments conducted to evaluate membrane cleanability and reusability. The membrane was cleaned by water rinse only for the first twenty-four tests, then by osmotic backwash achieved by switching feed and draw solution flows. Osmotic washing was carried out for three hours; then the membrane was rinsed by DI water until conductivity was below 10 μS. The membrane was washed with surfactant before the 30^{th} test. All experiments were conducted with a 400-mesh (37 microns) stainless steel screen mesh mounted and sealed on the top of the membrane to minimize direct contact between the slurry and the membrane surface.

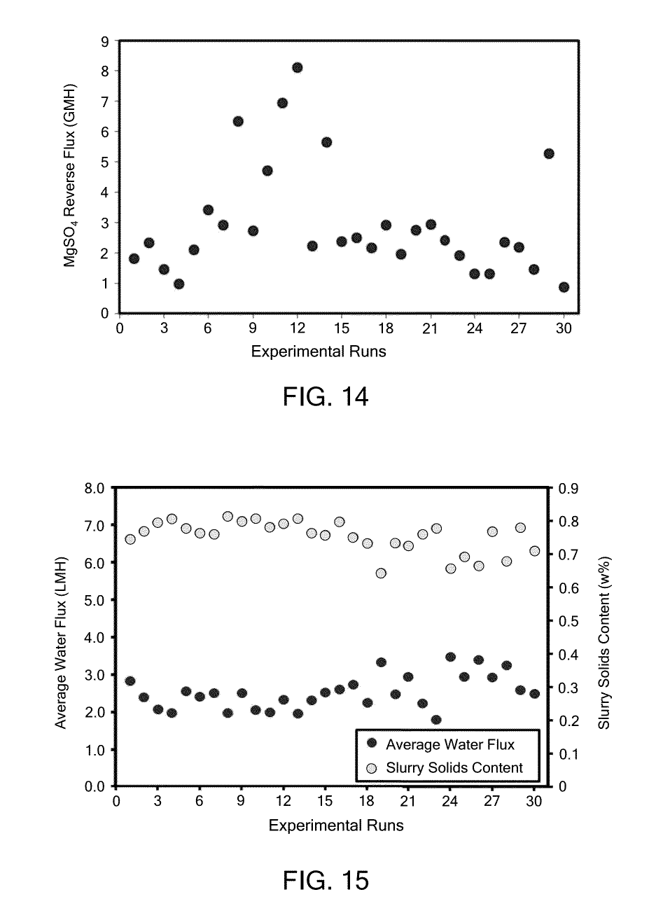

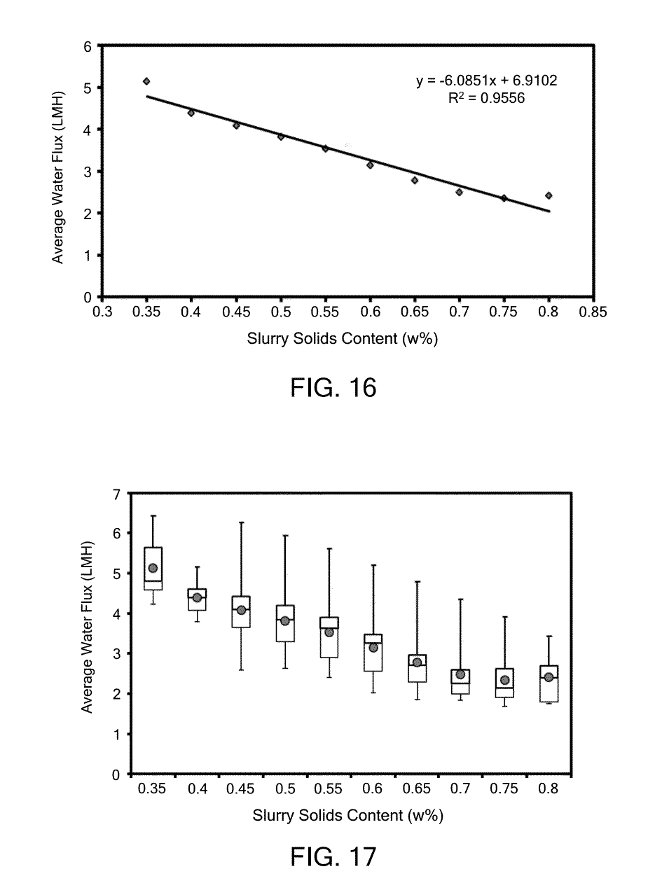

The robustness, cleanability, and reusability of the membrane are very important economic parameters. Membrane fouling is a major obstacle to the efficient application of membrane technology in various applications; however, the low risk of membrane fouling is one of the strengths of FO. The same piece of membrane was used repeatedly to evaluate the impact of irreversible fouling. In FIG. 13, average DI water flux (LMH) is plotted against the test number clearly showing the membrane's fouling resistance. Data also suggest that water rinse is sufficient to clean the membrane and achieves a flux recovery of 72%, which is likely to be increased by further optimization of the cleaning operation. Reverse salt flux of the membrane also appears to be holding well with no discernible deterioration as shown in FIG. 14. The observed outliers may be an artifact of inefficient rinsing. Average flux to obtain 70-80% slurry solids content was within a band of 1.8 and 3.0 LMH as shown in FIG. 15. An analysis of all runs reveals a linear relationship between average flux and slurry solids content as well as between average flux and variations in flux, as shown in FIGS. 16 and 17. Taken together, these results support the idea that the membrane used in the study seems to be relatively immune to fouling and is robust within the time frame of this study. Care was taken to avoid any direct abrasion of the membrane surface and this mode of failure was therefore not a major concern. If conditions for chemical deterioration of the membrane exist, preventive measures should be taken.

Membrane replacement costs can be lowered through productivity enhancement. The productivity of the process can be increased by maximizing driving force (minimizing osmotic pressure of slurry) and by decreasing cake resistance. Slurry TDS (and therefore osmotic pressure) for many coal preparation plants in Illinois are considerably lower than the ˜8500 mg/L measured for the Galatia Mine samples used in this work. For example, the thickener underflow at Peabody Energy's Willow Lake preparation plant had a TDS of ˜4000 mg/L and that of White County Coal Company's Pattiki Mine was 2200 mg/L. Hence, slurries from Willow Lake and Pattiki are expected to be processed with a higher average flux than that of the Galatia slurry. Osmotic pressure also can be decreased by water washing. This washing can be achieved without additional water consumption in the coal preparation circuit through use of water pinch technologies. Cake resistance can also be lowered by increasing particle size within slurries, or by increasing the sphericity of materials in the cake bed, as discussed above.

Scalability:

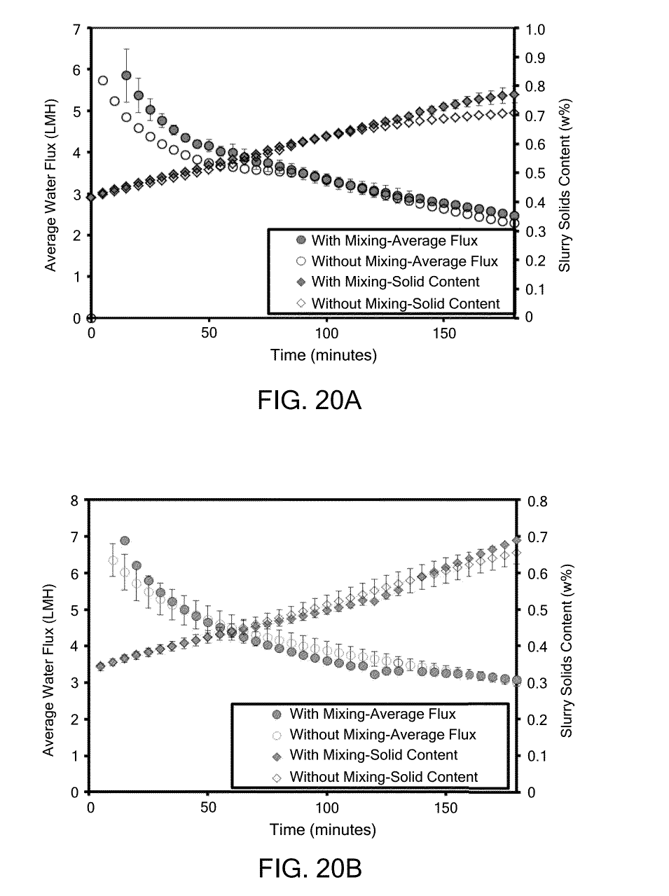

Results obtained with the exemplary rectangular FO system support the scalability of this configuration as seen in data obtained with the intermediate-sized dewatering cell, shown in FIG. 18, and the largest size dewatering cell, shown in FIG. 19, developed for this project. Results for the medium-sized FO cell, shown in FIGS. 20A and 20B, suggest a lower degree of sensitivity to mixing as opposed to that shown in FIG. 7. This is attributed to the presence of significant vibration caused by water flow in the intermediate cell. If verified, this opens up another method to prevent flux loss by cake formation and consolidation.

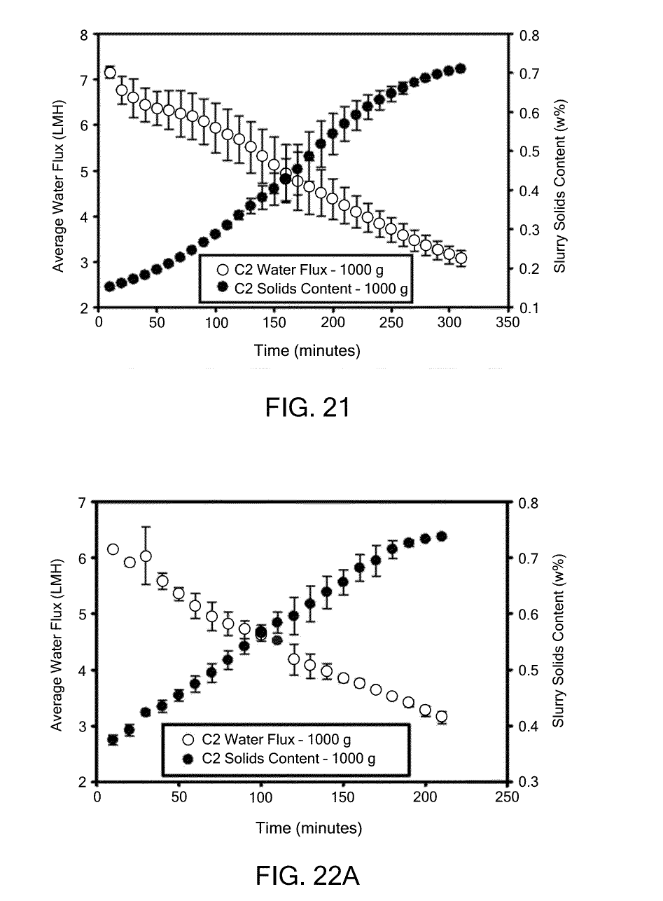

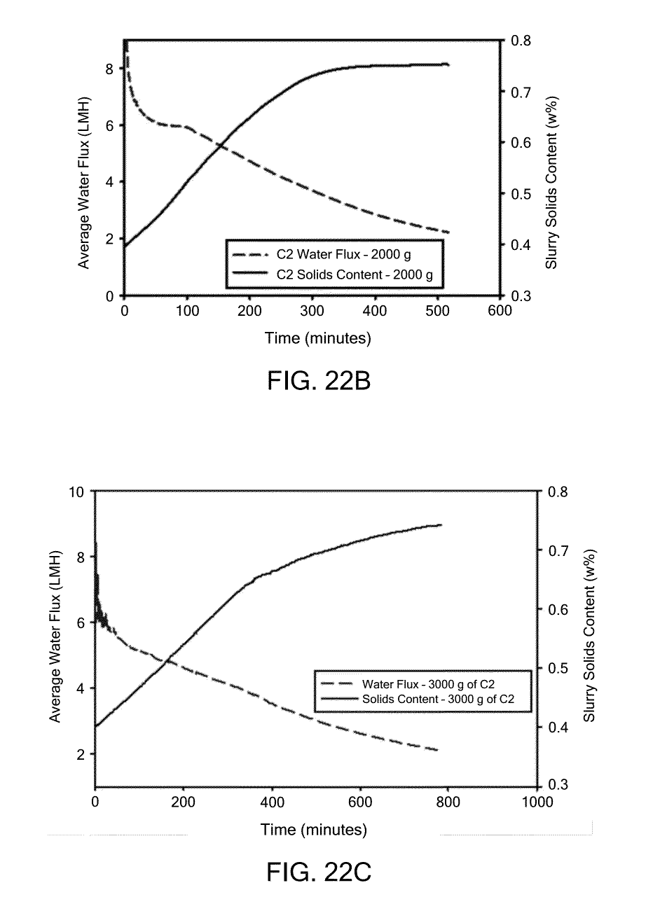

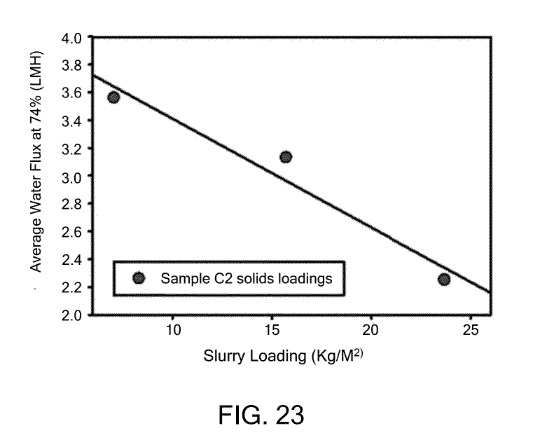

Several experiments were conducted using the large cell to dewater C1 and C2 samples as received from the coal preparation plant. The large cell showed good dewatering performance when used to dewater 1000 g of C1 as shown in FIG. 21. The time required to dewater this sample is longer due to lower solids content (about 15%) and larger amounts of water that must be removed. FIGS. 22A-22C depict data obtained for dewatering 1000, 2000, and 3000 g of sample C2, respectively. The average flux obtained in these experiments is between 2 and 3 LMH and close to that obtained with the smaller cell. These results are particularly interesting when examined as a function of solids loading per square meter of membrane area. Such a comparison reveals that the degradation in flux with an increase in solids loading (cake thickness) is slight. This suggests that the bulk of dewatering occurs without being limited by cake formation, as described in FIG. 23.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A system for dewatering slurries, the system comprising:
a tower comprising a stack of forward osmosis (FO) cells, each FO cell comprising a first portion for holding a feed slurry, a second portion for circulating a draw solution comprising an osmotic agent, and a semi-permeable membrane in between the first portion and the second portion, the first portion including an agitation mechanism for mixing the feed slurry,
wherein, during operation of the system, the feed slurry is transported downstream through the stack for dewatering to a predetermined solids content.

2. The system of claim 1, wherein the agitation mechanism comprises a rotatable and/or translatable rake or scraper.

3. The system of claim 1, wherein the agitation mechanism comprises a source of vibrational energy applied to the first portion.

4. The system of claim 1, wherein the agitation mechanism is automated.

5. The system of claim 1, wherein the semi-permeable membrane comprises an ultrafiltration membrane, a nanofiltration membrane, a reverse osmosis membrane, or a forward osmosis membrane.

6. The system of claim 1, further comprising a protective layer on a side of the semi-permeable membrane facing the first portion.

7. The system of claim 5, wherein the protective layer comprises a screen mesh comprising a metal or a polymer, and wherein the screen mesh comprises a pore size distribution in the range of from about 20 microns to about 60 microns.

8. The system of claim 1, wherein a first gasket is disposed between the semi-permeable membrane and the first portion and a second gasket is disposed between the semi-permeable membrane and the second portion to form a leak-proof seal.

9. The system of claim 1, wherein the first portion is open to ambient atmosphere.

10. The system of claim 1, wherein the second portion further comprises an inset channel for circulation of the draw solution.

11. The system of claim 1, wherein each FO cell comprises a retractable plug for regulating the flow of slurry downstream through the stack.

12. The system of claim 1, wherein each FO cell comprises a rectangular parallelepiped or a cylindrical configuration, and
wherein the stack includes n FO cells, where 2≦n≦100.

13. A method of dewatering slurries, the method comprising:
delivering a feed slurry to be dewatered into a first forward osmosis (FO) cell, the first FO cell being one of a plurality of FO cells stacked to form a tower, each of the FO cells comprising a first portion separated from a second portion thereof by a semi-permeable membrane, the feed slurry being delivered into the first portion of the first FO cell;
mixing the feed slurry in the first portion;
flowing a draw solution comprising an osmotic agent through the second portion, thereby generating an osmotic pressure gradient between the first portion and the second portion of the first FO cell;
removing water from the feed slurry to form a dewatered slurry, the osmotic pressure gradient inducing water from the feed slurry to flow through the semi-permeable membrane to the second portion of the first FO cell; and
transporting the dewatered slurry to an adjacent downstream FO cell and carrying out the mixing of the slurry, flowing of the draw solution, and removal of water in the adjacent downstream FO cell,
wherein the transporting, mixing, flowing and removal are repeated until the dewatered slurry reaches a final solids content of at least about 60%.

14. The method of claim 13, wherein the final solids content is at least about 70%.

15. The method of claim 13, wherein the feed slurry comprises waste material obtained from mining, manufacturing, water treatment or biotechnology.

16. The method of claim 15, wherein the feed slurry comprises coal particles.

17. The method of claim 13, wherein the draw solution is an aqueous solution comprising an osmotic pressure of at least about 10 psi.

18. The method of claim 13, wherein the osmotic agent is selected from the group consisting of: sodium chloride, magnesium sulfate (MgSO₄), a thermolytic salt, or another monovalent and/or divalent salt; glycerol; sucrose; a switchable polarity solvent; and a polymer.

19. The method of claim 13, further comprising adding substantially spherical particles to the feed slurry prior to delivering the feed slurry to the first FO cell.

20. The method of claim 13, wherein the water is removed at an average rate of from about 2 LMH to about 20 LMH.
